(19) United States
(12) Patent Application Publication
(10) Pub. No.: US 2025/0303540 A1
(43) Pub. Date: Oct. 2, 2025

(54) SCHRADER VALVE CORE TOOL

(71) Applicant: Procure Trading, LLC, Willow Street, PA (US)

(72) Inventor: Todd McMichael, Leesburg, VA (US)

(21) Appl. No.: 19/090,604

(22) Filed: Mar. 26, 2025

Related U.S. Application Data
(60) Provisional application No. 63/570,091, filed on Mar. 26, 2024.

(51) Int. Cl. B25B 27/24

(52) U.S. Cl. CPC B25B 27/24

(57) ABSTRACT

A Schrader valve core tool includes a driver rod extending from a handle at a first end thereof and a tip at a second end of the driver rod, the second end opposite the first end. The tip includes a fork configured to connect with a Schrader valve core connecting tip for removal or installation through a rotational motion of a threaded valve core. The fork includes a stepdown having at least one stop thereby providing alignment of the Schrader valve core tool and the threaded valve core.

### CROSS-REFERENCE TO RELATED APPLICATION

The present application claims priority from and the benefit of U.S. Provisional Patent Application No. 63/570,091, filed on Mar. 26, 2024, which is hereby incorporated by reference for all purposes as if fully set forth herein.

### BACKGROUND

### Field

Exemplary embodiments relate to a valve core tool including a fork for alignment and positive mating thereof with a Schrader valve core.

### Discussion of the Background

Exemplary embodiments of the present inventive concept relate to a device for removal or installation of a Schrader valve core respectively from or into a Schrader valve. Removing a valve core from a valve may be for the purpose of deflating the tire to a user-determined lower air pressure. Schrader valve core removal tools are based on the premise that airflow through a tire stem having a Schrader valve is maximized when the valve core thereof is removed, allowing unrestricted airflow through the tire stem. To achieve removal of the Schrader valve core, the valve core removal tool must successfully mate to the Schrader valve core, after which the core may be unscrewed by a user.

Two common uses of a Schrader valve core removal tool are on automotive tires and in commercial refrigeration servicing. In automotive tires removing the Schrader valve core allows for rapid tire deflation. In refrigeration servicing, Schrader valve core removal is typically for valve replacement. The simplified valve core removal process is: 1) secure the valve core removal tool to the threaded stem that houses the Schrader valve core; 2) mate a slotted fork of the valve core removal tool controlled by connecting rod and knob within a sealed pressure capsule; and 3) unscrew the Schrader valve core from its housing by turning the connecting rod about 180 degrees.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a valve core tool including a fork for alignment and positive mating thereof with a Schrader valve core.

Additional aspects will be set forth in the detailed description which follows, and, in part, will be apparent from the disclosure, or may be learned by practice of the inventive concept.

According to exemplary embodiments, a Schrader valve core tool includes a driver rod extending from a handle at a first end thereof and a tip at a second end of the driver rod, the second end opposite the first end. The tip includes a fork configured to connect with a Schrader valve core connecting tip for removal or installation through a rotational motion of a threaded valve core. The fork includes a stepdown having at least one stop thereby providing alignment of the Schrader valve core tool and the threaded valve core.

According to exemplary embodiments, a valve core tool includes a driver rod having a handle at a first end and a forked tip at a second end. The forked tip includes an inclined surface extending from an outer perimeter thereof toward a recess and a stop at an end of the inclined surface. The stop is configured to induce engagement between the recess and a valve core when the tool is rotated with forward axial pressure.

According to exemplary embodiments, a valve core tool for aligning with and rotating a Schrader valve core, the valve core tool including a driver rod having a distal end and a fork disposed on the distal end of the driver rod, the fork defining a recess to receive a connecting tip of the Schrader valve core.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 shows a Schrader valve and a common design of a Schrader valve core removal tool.

FIG. 2 shows a partial front perspective view of a Schrader valve core tool according to an exemplary embodiment.

FIG. 3A and FIG. 3B show a front view of the Schrader valve core tool according to the exemplary embodiment of FIG. 2.

FIG. 4A and FIG. 4B show a side view of the Schrader valve core tool according to the exemplary embodiment of FIG. 2.

FIG. 5A and FIG. 5B show another side view of the Schrader valve core tool according to the exemplary embodiment of FIG. 2.

FIG. 6 shows another side view of the Schrader valve core tool according to the exemplary embodiment of FIG. 2.

### DETAILED DESCRIPTION OF THE ILLUSTRATED EMBODIMENTS

In the following description, for the purposes of explanation, numerous specific details are set forth in order to provide a thorough understanding of various exemplary embodiments. This disclosure may, however, be embodied in different forms and should not be construed as limited to the exemplary embodiments set forth herein. Various embodiments may be practiced without these specific details or with one or more equivalent arrangements.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

To achieve removal of a Schrader valve core, a valve core removal tool must successfully mate to the valve core, after which the core may be unscrewed. This mating connection has an inherent design weakness, causing user frustration and common failed attempts to remove the valve core. The difficulty in making a proper connection between the valve core removal tool and the valve core is a result of at least two factors. First, a blind connection must be made, meaning the user cannot visually align the valve core removal tool with the valve core. Second, a connecting rod of the valve core removal tool may require one or more O-rings to keep a closed pressure capsule. O-rings mask user sensory feel, which is critical for making a positive connection. Accordingly, a user cannot see or easily feel the engagement of the valve core removal tool and valve core.

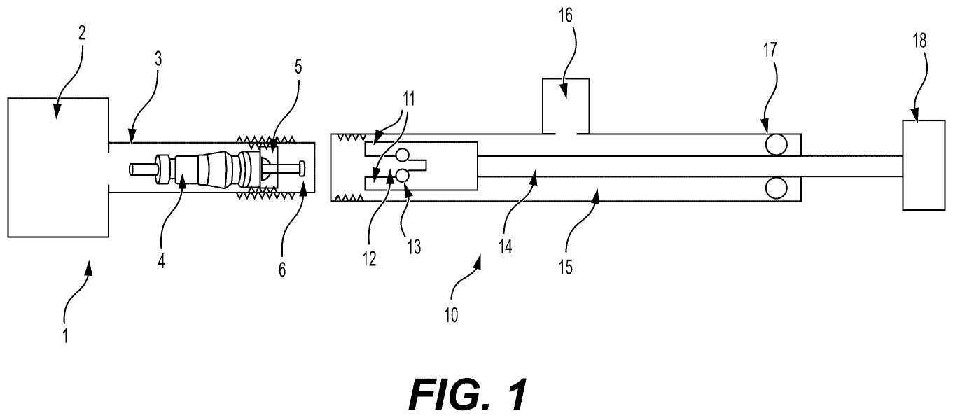

Existing Schrader valve core tool designs comprise a cylindrical rod with a driver handle on one end and simple fork shaped receiving receptacle on the opposing end. The fork element incorporates a rectangular recessed notch designed to receive the joining end of a Schrader valve core, which comprises of a blunt rectangular blade shaped plug. FIG. 1 shows a fluid-containing device 1 with a fluid container 2 and a stem 3 extending therefrom. The stem 3 has a Schrader valve core 4 disposed therein, and the Schrader valve core 4 has a connecting tip 5 and a pin head 6.

A Schrader valve core tool 10 has a fork 11, a fork slot 12 therebetween, pin-retaining O-rings 13, a connecting rod 14, a pressure capsule 15, port 16, sealing O-rings 17, and a knob 18. The fork 11 of the Schrader valve core tool 10 must mate with the connecting tip 5 of the Schrader valve core 4 to engage the core.

However, the fork 11 and the connecting tip 5 only align in a single rotational position of the fork 11, these may not connect on a first attempt by a user. Rather, the user must rotate the connecting rod 14 to locate the correct position of the fork 11 relative to the connecting tip 5. The user may falsely believe the fork 11 and the connecting tip 5 have mated, and may spend time unscrewing the empty connecting rod 14, and the consequence is frustration and wasted time.

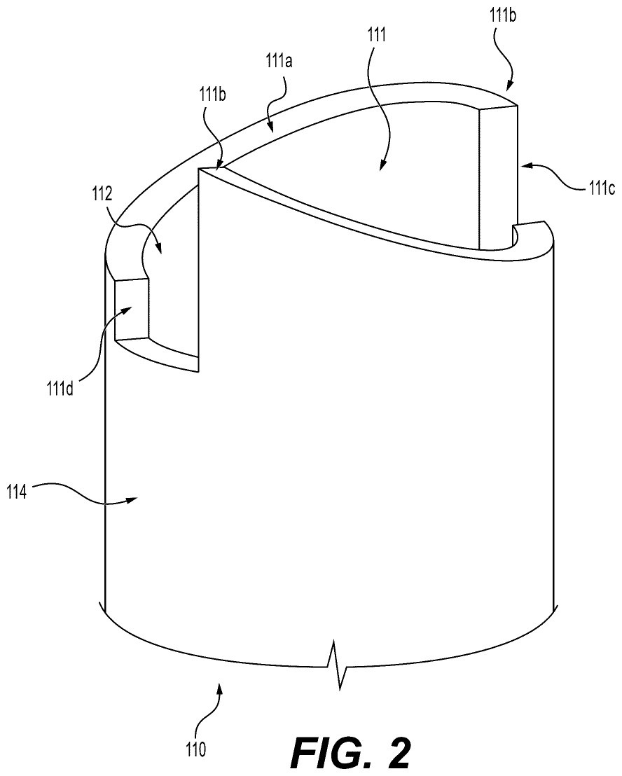

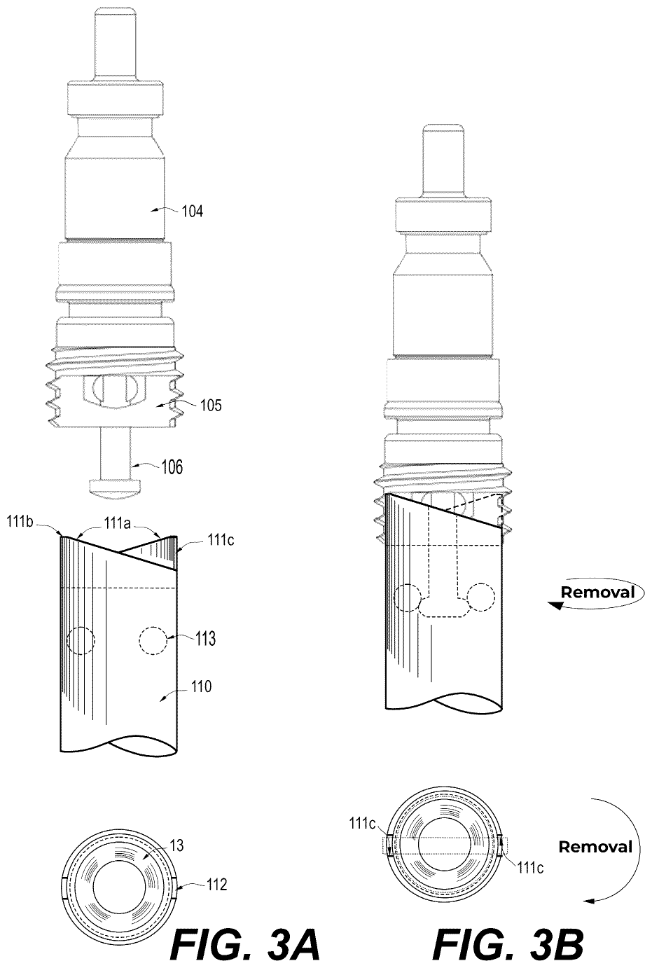

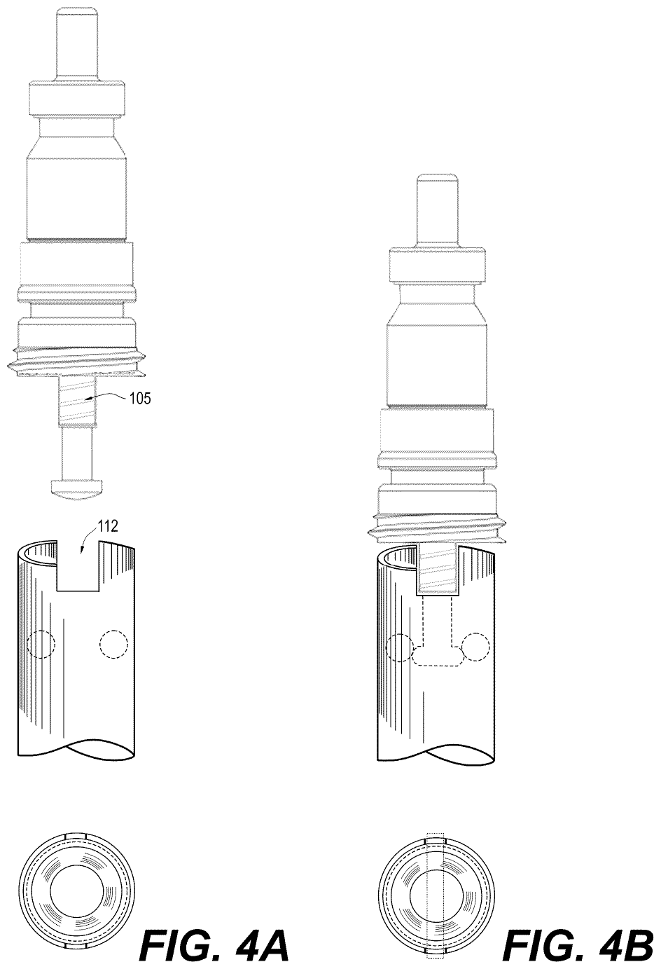

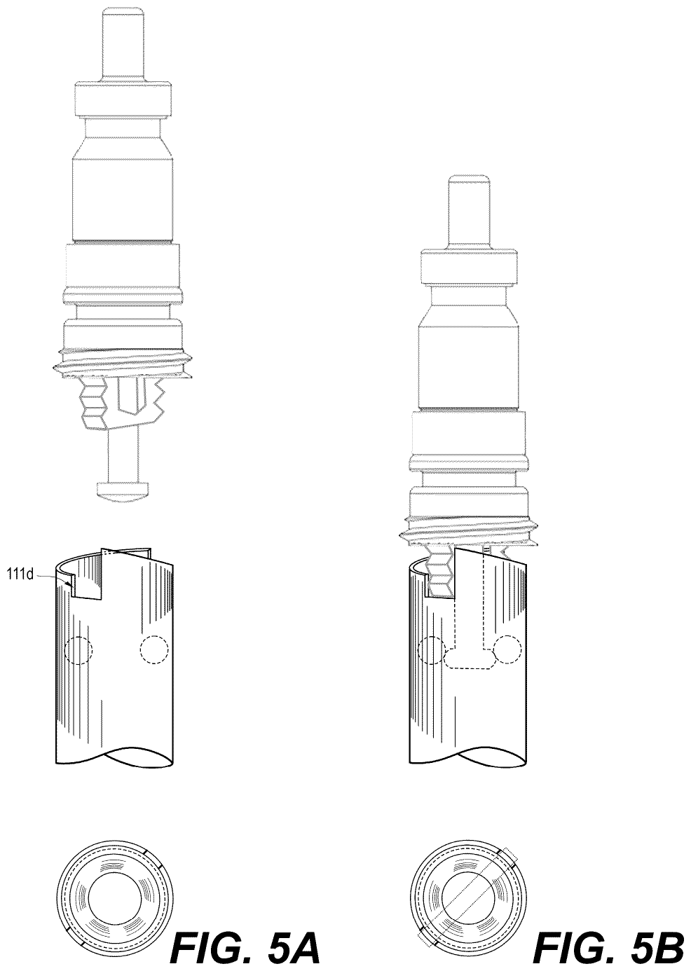

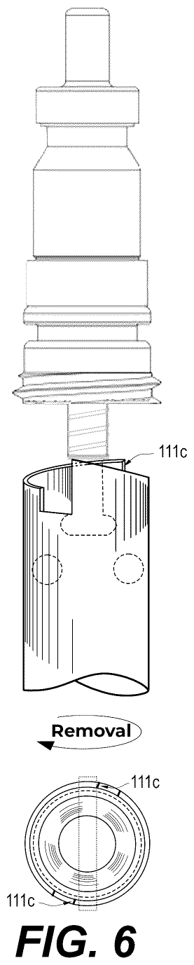

According to exemplary embodiments, as shown in FIG. 2, FIG. 3A, FIG. 3B, FIG. 4A, FIG. 4B, FIG. 5A, FIG. 5B, and FIG. 6, a valve core tool 110 includes an innovative design of a fork 111, which guides the fork 111 into a proper alignment and positive mating with a connecting tip 105 of a Schrader valve core 104. In particular, the fork 111 may include a stepdown element, which may include physical stops that guide alignment of a driver (e.g., connecting rod 114) and the Schrader valve core 104 to assure a quick and trouble-free connection, particularly when used in application where the fork end of the driver is contained within a shrouded pressure chamber (e.g., pressure capsule 15 as shown in FIG. 1). The fork 111 and the connecting rod 114 may be integrally formed, as shown in FIG. 2, but embodiments are not limited thereto.

The valve core tool 110 may otherwise be substantially similar to the valve core tool 10 as shown and described with respect to FIG. 1, and the disclosure thereof is incorporated herein by reference. However, embodiments are not limited thereto, and the valve core tool 110 may be different in various respects from the valve core tool 10.

Schrader valve core 104 removal and installation is driven by rotation of the valve core tool 110 by a user. Proper alignment and engagement of the connecting tip 105 with a recess 112 is required for the valve core tool 110 to rotate the Schrader valve core 104 in both tightening (clockwise rotation) or loosening (counter-clockwise rotation) directions. To loosen the Schrader valve core 104, the valve core tool 110 may be driven in a counter-clockwise rotation with forward pressure engaging the Schrader valve core 104.

When the radial position of the valve core tool 110 in relation to the connecting tip 105 aligns exactly (which is statistically infrequent when no visual alignment is possible), the connecting tip 105 resides firmly in the recess 112. The connecting tip 105 typically has a flat blade shape, so the recess 112 according to the present exemplary embodiment has a corresponding rectangular shape, but embodiments are not limited thereto. The base of the recess 112 is shown as a dashed line on the valve core tool 110 in FIG. 3A and FIG. 3B. Thereafter, continued counter-clockwise rotation of the valve core tool 110 may continue to drive the Schrader valve core 104 until the desired new position of the Schrader valve core 104 is reached, at which time the valve core tool 110 may be retracted.

When the valve core tool 110 engages the connecting tip 105 without exact alignment, as shown in FIG. 6, as forward pressure and counter-clockwise rotation continues, the connecting tip 105 may remain stationary as the valve core tool 110 incrementally envelops the connecting tip 105 until striking the stop 111c of the fork 111. This may occur synchronously on opposite sides of the valve core tool 110. The recess 112 may thereby be properly aligned with the connecting tip 105, and the connecting tip 105 may insert firmly into the recess 112. Once the connecting tip 105 is inserted into the recess 112, the pin head 106 of the Schrader valve core 104 may be seated adjacent to O-rings 113 inside of the valve core tool 110. Rotation of the Schrader valve core 104 may then continue with the rotation of the valve core tool 110 until a desired position of the Schrader valve core 104 relative to a stem (not shown) is achieved, typically until fully unscrewed from the stem (i.e., a Schrader valve body).

As the user of the valve core tool 110 applies forward pressure to the knob thereof (18, as shown in FIG. 1) while turning the connecting rod 114 counterclockwise, within less than 180° of rotation, the stop 111c of the fork 111 intersects with the Schrader valve core 104 itself. The stop 111c acts as a physical stop in un-engaged rotation at the correct alignment position, resulting in full and proper engagement of the fork 111 with the connecting tip 105. Rotational force is transmitted to the connecting tip 105 via the vertical surface of the stop 111c.

The vertical physical stops represented by stops 111c force alignment between the connecting tip 105 and the recess 112. The physical stops result from the step down between position 0 degrees and 180 degrees of rotation, and likewise between 180 degrees and 360 degrees rotation of the valve core tool 110. This stepdown may be achieved by inclined surface (i.e., inclined plane) 111a of an appropriate slope. According to the present exemplary embodiment, the inclined surface 111a has an angle of about 15 degrees. However, embodiments are not limited thereto. For example, the inclined surface 111a may instead be a stepped (i.e., non-sloped) surface, incremental step, or series of step-downs of appropriate depth.

An offset 111b may be formed at the intersection of the inclined surface 111a and the stop 111c of the fork 111, so the inclined surface 111a does not otherwise create a hazardous sharp edge with the fork slot 112. The offset 111b may be present on each inclined surface 111a of the valve core tool 110, but embodiments are not limited thereto. Normally the fork 111 may not protrude from the valve core tool 110, but there is no functional purpose for the inclined surface 111a to start at the fork slot 112 edge (that is, the stop 111c), and thus create a pointed area. Accordingly, the offset 111b may be a safety feature of the valve core tool 110. For installation or any clockwise rotation of the Schrader valve core 104 within a threaded valve bore (i.e., the Schrader valve body), the Schrader valve core 104 may be manually pre-loaded into the recess 112 by the user or other appropriate device prior to insertion. In some applications, the Schrader valve core 104 remains held in the pressure chamber (e.g., the pressure capsule 115) following a subsequent removal procedure.

Driven with forward pressure in a clockwise rotation, the valve core tool 110 transmits rotational force to the Schrader valve core 104 via a vertical surface 111d. Rotation continues synchronously with the valve core tool 110 until a desired new position of the Schrader valve core 104 is achieved, at which time the valve core tool 110 may be retracted from the Schrader valve core 104.

To achieve sufficient vertical surface area of both the stop 111c and the vertical surface 111d, such as to effectuate removal or installation of the Schrader valve core 104 with the valve core tool 110, the total depth of the recess 112 may be proportionally shared. In other words, the surface area of stop 111c and vertical surface 111d sufficiently support both clockwise and counter-clockwise operations of the valve core tool 110.

That is, the total depth of the recess 112 minus the height of vertical surface 111d may define the area of the stop 111c. The total height of vertical surface 111d may define the area where clockwise rotational force may be applied to the valve core 104. The total height of recess 112 may define the area where counter-clockwise rotational force may be applied to the valve core 104, including but not limited to the stop 111c.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A Schrader valve core tool comprising:
a driver rod extending from a handle at a first end thereof; and
a tip at a second end of the driver rod, the second end opposite the first end, wherein:
the tip comprises a fork configured to connect with a Schrader valve core connecting tip for removal or installation through a rotational motion of a threaded valve core, and
the fork comprises a stepdown having at least one stop thereby providing alignment of the Schrader valve core tool and the threaded valve core.

2. The Schrader valve core tool of claim 1, wherein the stepdown comprises an inclined surface configured to provide a smooth transition to the at least one stop at a point of proper alignment of the Schrader valve core tool and the threaded valve core.

3. The Schrader valve core tool of claim 1, wherein the stepdown comprises at least one tiered step leading to the at least one stop at a point of proper alignment of the Schrader valve core tool and the threaded valve core.

4. The Schrader valve core tool of claim 2, wherein the stepdown comprises an offset perpendicular to a longitudinal axis of the Schrader valve core tool and formed at a tip of the inclined surface thereof.

5. A valve core tool, comprising:
a driver rod having a handle at a first end and a forked tip at a second end,
wherein the forked tip includes:
an inclined surface extending from an outer perimeter thereof toward a recess; and
a stop at an end of the inclined surface,
wherein the stop is configured to induce engagement between the recess and a valve core when the tool is rotated with forward axial pressure.

6. The valve core tool of claim 5, wherein the stop comprises a vertical face configured to engage a flat surface of a connecting tip of the valve core.

7. The valve core tool of claim 6, wherein the inclined surface has an angle of approximately 15 degrees relative to a longitudinal axis of the valve core tool.

8. The valve core tool of claim 7, wherein the inclined surface includes an offset region between the stop and the inclined surface.

9. The valve core tool of claim 8, wherein the forked tip comprises a symmetrical structure allowing engagement of the valve core from multiple rotational orientations.

10. The valve core tool of claim 9, wherein the stop includes an engagement surface for transmitting rotational force during counterclockwise motion.

11. The valve core tool of claim 10, wherein the recess depth is proportionally divided between the vertical surface and the stop for transmitting torque in both clockwise and counterclockwise directions.

12. The valve core tool of claim 11, wherein the stop is configured to make contact with the connecting tip of the valve core after less than 180 degrees of rotation when forward axial pressure is applied.

13. The valve core tool of claim 5, further comprising an O-ring disposed around the forked tip for pressure sealing within a pressure capsule.

14. The valve core tool of claim 5, wherein the forked tip and the driver rod are integrally formed as a single component.

15. A valve core tool for aligning with and rotating a Schrader valve core, the valve core tool comprising:
a driver rod having a distal end; and
a fork disposed on the distal end of the driver rod, the fork defining a recess to receive a connecting tip of the Schrader valve core,
wherein the fork includes at least one physical stop disposed adjacent to the recess and configured to guide the connecting tip into a proper rotational alignment.
